(19) United States
(12) Patent Application Publication
(10) Pub. No.: US 2005/0221138 A1
(43) Pub. Date: Oct. 6, 2005

(54) Fuel cell system

(75) Inventors: Aravind Dattatrayrao Chinchure, Kundalahalli (IN); Hari Ns, Bangalore (IN); Amitabh Verma, Bangalore (IN); Sheela Kollali Ramasesha, Bangalore (IN); Kaushik Vaidya, Bangalore (IN)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/814,738

(22) Filed: Apr. 1, 2004

(51) Int. Cl. H01M 8/10; H01M 2/14

(52) U.S. Cl. 429/32; 429/38; 429/39; 429/30; 429/33

(57) ABSTRACT

In one aspect, a fuel cell assembly comprises a plurality of fuel cells. Each of the fuel cells includes an anode layer, a cathode layer and an electrolyte interposed therebetween. The fuel cell further comprises a conducting layer in intimate contact with at least one of the cathode layer and the anode layer. The conducting layer is configured to facilitate transport of electrons from the anode layer and the cathode layer.

### BACKGROUND OF THE INVENTION

This invention relates generally to fuel cells and more specifically to improved current collection systems in fuel cells.

A fuel cell produces electricity by catalyzing fuel and oxidant into ionized atomic hydrogen and oxygen at the anode and the cathode, respectively. The electrons removed from hydrogen in the ionization process at the anode are conducted to the cathode where they ionize the oxygen. In the case of a solid oxide fuel cell, the oxygen ions are conducted through the electrolyte where they combine with ionized hydrogen to form water as a byproduct and complete the process. The electrolyte is otherwise impermeable to both fuel and oxidant and merely conducts oxygen ions. This series of electrochemical reactions is the sole means of generating electric power within the fuel cell

The fuel cells are typically assembled in electrical series in a fuel cell assembly to produce power at useful voltages. To create a fuel cell assembly, an interconnecting member is used to connect the adjacent fuel cells together in electrical series. The conventional interconnect design has a series of channels on both sides of the interconnect to provide passages for reactants, such as a fuel and an oxidant. This conventional interconnect design provides limited contact area of the interconnect with the electrodes, which limited area contact prevents an efficient current collection in a fuel cell. Typically in an intermediate temperature fuel cell, metallic materials are used as interconnect materials due to their high electrical and thermal conductivities and ease of fabrication. Fuel cells, such as solid oxide fuel cell are operated at high temperatures between approximately 600° degree Celsius (C) and 1000 degree Celsius. The stability of the metallic materials at a high temperature is a concern, as some of the metallic materials, such as, high temperature oxidation resistant alloys form a protective semi-conducting or insulating oxide layers on the surface thereby reducing the electrical conductivity of the alloys.

Therefore there is a need to design a fuel cell assembly that has an efficient current collection system and also improves the oxidation resistance of the interconnects.

### BRIEF DESCRIPTION OF THE INVENTION

In one aspect, a fuel cell assembly comprises a plurality of fuel cells. Each of the fuel cells includes an anode layer, a cathode layer and an electrolyte interposed therebetween. The fuel cell further comprises a conducting layer in intimate contact with at least one of the cathode layer and the anode layer. The conducting layer is configured to facilitate transport of electrons from the anode layer and the cathode layer.

In another aspect, a fuel cell assembly comprises a plurality of fuel cells. Each of the fuel cells includes an anode layer, a cathode layer and an electrolyte interposed therebetween. Each fuel cell further comprises an anode interconnect to support the anode layer and a cathode interconnect to support the cathode layer and a conducting layer disposed on at least one of the cathode layer and the anode layer. The conducting layer reduces the interface resistance between the anode layer and the anode interconnect and between the cathode layer and the cathode interconnect. The conducting layer is configured to facilitate transport of electrons from the anode layer and the cathode layer.

In yet another aspect, a fuel cell assembly comprises a plurality of fuel cells. Each of the fuel cells includes an anode layer, a cathode layer and an electrolyte interposed therebetween. Each fuel cell further comprises an anode interconnect to support the anode layer and a cathode interconnect to support the cathode layer; and a conducting layer disposed on at least one of the cathode layer and the anode layer. The conducting layer reduces the interface resistance between the anode and the anode interconnect and between the cathode layer and the cathode interconnect. At least one of the anode interconnect and the cathode interconnect is a hollow manifold comprising a top wall, a first side wall and a second side wall The top wall, first side wall and second side wall defines a chamber therein. The top wall comprises at least one opening extending therethrough in flow communication with the chamber. The conducting layer is configured to facilitate transport of electrons from the anode layer and the cathode layer.

### DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a diagrammatical view of a portion of an exemplary fuel cell assembly with a conducting layer in intimate contact with electrodes;

FIG. 2 illustrates a diagrammatical view of an exemplary conducting layer on the electrode;

FIG. 3 illustrates a diagrammatical view of yet another exemplary conducting layer on the electrode;

FIG. 4 illustrates the perspective view of an exemplary interconnect;

FIG. 5 illustrates the perspective view of yet another exemplary interconnect;

FIG. 6 illustrates the perspective view of an exemplary cathode interconnect with flow channels;

FIG. 7 illustrates the perspective view of yet another exemplary interconnect with cross current flow; and

FIG. 8 illustrates the perspective view of yet another exemplary interconnect.

### DETAILED DESCRIPTION OF THE INVENTION

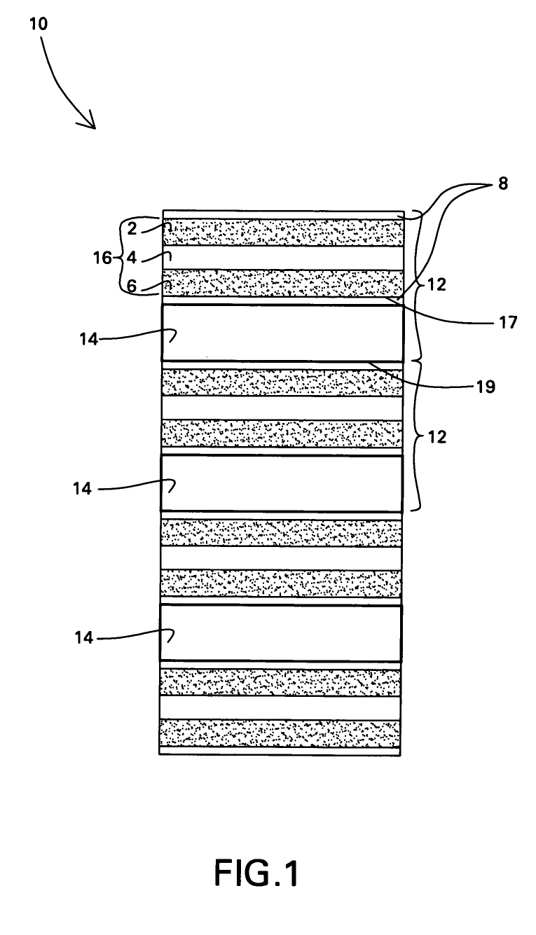

Fuel cells, such as solid oxide fuel cells, have demonstrated a potential for high efficiency and low pollution power generation. A fuel cell is an energy conversion device that produces electricity by electrochemically combining a fuel and an oxidant across an ionic conducting layer. Fuel cells may have planar or tubular configurations. Fuel cells may be stacked together either in series or in parallel to construct the fuel cell architecture, capable of producing a resultant electrical energy output. FIG. 1 illustrates a diagrammatical view of a portion of an exemplary fuel cell assembly 10 that comprises a plurality of repeating units 12. Each repeating unit 12 comprises a cell 16, and an interconnect 14. The cell 16 in each repeating unit comprises an anode layer 2, a conducting layer 8 in intimate contact with the anode layer 2, a cathode layer 6, another conducting layer 8 in intimate contact with the cathode layer 6 and an electrolyte 4 disposed therebetween. The cell 16 is supported by the interconnect 14. In some embodiments, the interconnect 14 acts as a bipolar element, wherein the cathode side 17 of the interconnect 14, which cathode side 17 is adjacent to the cathode layer 6 of one repeating unit 12, acts as a cathode interconnect. The anode side 19 of the interconnect 14, which anode side 19 is adjacent to the anode layer 2 of the next repeating unit 12, acts as an anode interconnect. In accordance with the present technique, interconnect 14 further acts as the oxidant and the fuel separator in the fuel cell assembly 10. In some embodiments, the conducting layer 8 has a mesh like structure, which conducting layer 8 is disposed on the cathode layer 6 and anode layer 2 to increase the current collection efficiency in the fuel cell assembly 10, as described in more details in the following sections. The conducting layer 8 also increases the oxidation resistance of the interconnect 14. As used herein, “intimate contact” will be understood to generally imply a physical proximity of the conducting layer 8 and the electrodes and includes an exemplary configuration wherein the conducting layer is disposed on the electrodes and another exemplary configuration wherein the conducting layer is disposed on the interconnect and is adjacent to the electrodes.

In the exemplary cell 16, such as the solid oxide fuel cell (SOFC), oxygen ions (O²⁻) generated at the cathode are transported across the electrolyte interposed between the anode and the cathode. The fuel, for example natural gas, is fed to the anode. The fuel at the anode reacts with oxygen ions (O²⁻) transported to the anode across the electrolyte. The oxygen ions (O²⁻) are de-ionized to release electrons to an external electric circuit (not shown). The electron flow thus produces direct current electricity across the external electric circuit.

In the exemplary embodiment as shown in FIG. 1, the fuel cell assembly 10 comprises a plurality of repeating units 12 having a planar configuration, although multiple such cells may be provided in a single structure, which structure may be referred to as a stack or a collection of cells or an assembly. The fuel cell may be one of solid oxide fuel cells, direct methanol fuel cells, and protonic ceramic fuel cells. An oxidant flows in the cathode side of the cell 16 and a fuel flows in the anode side of the cell 16.

The main purpose of the anode layer 2 is to provide reaction sites for the electrochemical oxidation of a fuel introduced into the fuel cell. In addition, the anode material should be stable in the fuel-reducing environment, have adequate electronic conductivity, surface area and catalytic activity for the fuel gas reaction at the fuel cell operating conditions and have sufficient porosity to allow gas transport to the reaction sites. The anode layer 2 can be made of a number of materials having these properties, including but not limited to, noble metals, transition metals, cermets, ceramics and combinations thereof. More specifically the anode layer 2 may be made of any materials selected from the group consisting of Ni, Ni Alloy, Ag, Cu, Cobalt, Ruthenium, Ni—YSZ cermet, Cu—YSZ cermet, Ni—Ceria cermet, or combinations thereof.

The electrolyte 4 is disposed upon the anode layer 2 typically via tape casting or tape calandering. The main purpose of the electrolyte layer is to conduct ions between the anode layer 2 and the cathode layer 6. The electrolyte carries ions produced at one electrode to the other electrode to balance the charge from the electron flow and complete the electrical circuit in the fuel cell. Additionally, the electrolyte separates the fuel from the oxidant in the fuel cell. Accordingly, the electrolyte must be stable in both the reducing and oxidizing environments, impermeable to the reacting gases and adequately conductive at the operating conditions. Typically, the electrolyte 4 is substantially electronically insulating. The electrolyte 4 can be made of a number of materials having these properties, including but not limited to, ZrO2, YSZ, doped ceria, CeO2, Bismuth sesquioxide, pyrochlore oxides, doped zirconates, perovskite oxide materials and combinations thereof.

The electrolyte layer 4 has a thickness such that electrolyte is substantially gas impermeable. The thickness of the electrolyte 4 is typically less than 50 microns, preferably in the range between about 0.1 microns thick to about 10 microns, and most preferably in the range between about 1 microns thick to about 5 microns thick.

The cathode layer 6 is disposed upon the electrolyte 4. The main purpose of the cathode layer 6 is to provide reaction sites for the electrochemical reduction of the oxidant. Accordingly, the cathode layer 6 must be stable in the oxidizing environment, have sufficient electronic and ionic conductivity, surface area and catalytic activity for the oxidant gas reaction at the fuel cell operating conditions and have sufficient porosity to allow gas transport to the reaction sites. The cathode layer 6 can be made of a number of materials having these properties, including but not limited to, an electrically conductive oxide, perovskite, doped LaMnO3, tin doped Indium Oxide (In2O3), Strontium-doped PrMnO3; La ferrites, La cobaltites, RuO2-YSZ, and combinations thereof.

Some of the functions of a typical interconnect in a planar fuel cell assembly, are to provide electrical contact between the fuel cells connected in series or parallel, provide fuel and oxidant flow passages and provide structural support. Ceramic, cermet and metallic alloy interconnects are typically used as interconnects. Metallic materials have certain advantages, when used as an interconnect material because of their high electrical and thermal conductivities, ease of fabrication and low cost. In some embodiments, the fuel cell assembly may comprise fuel cells with planar configuration, tubular configuration or a combination thereof.

However, instability of the metallic materials in a fuel cell environment limits number of metals that can be used as interconnects. Typically, the high temperature oxidation resistant alloys form protective oxide layers on the surface, which oxide layers reduce the rate of oxidation reaction. Chromium (Cr) containing alloys are used as interconnect materials because these alloys form a protective chromium oxide (Cr₂O₃) layer on the surface which exhibits reasonable electronic conductivity, though not as high as the conductivity of the alloys themselves. However, for high temperature operations in a fuel cell, such as solid oxide fuel cell (SOFC) applications, the evaporation of oxides and oxyhydroxides of Cr on the cathode side and diffusion of Cr into the anode and the cathode leads to higher over potentials at the interfaces thus resulting in higher performance degradation of the cell. As disclosed herein, the conducting layer having a mesh like structure on the electrodes increases the current collection efficiency from the anode and the cathode and also increases the oxidation resistance of the metallic interconnect.

Returning to FIG. 1, the anode layer 2 is in intimate contact with the interconnect 14 at the anode side 19 of the interconnect 14. In conventional fuel cells, the anode layer and the cathode layer are bonded to the interconnect using a bond paste. In the exemplary embodiment, as shown in FIG. 1, the conducting layer 8 is chemically compatible with the interconnect 14. Therefore the cell 16 may directly be disposed on the interconnect 14 without using a bond paste. The interface resistance at the interface of interconnect 14 and the anode layer 2 at the anode side 19 is substantially eliminated in presence of the conducting layers 8. Similarly, the interface resistance at the interface of interconnect 14 and the cathode layer 6 at the cathode side 17 is substantially eliminated in the presence of the conducting layers 8. FIG. 1 only gives the diagrammatical view of the positions of different elements of each repeating unit in the exemplary fuel cell assembly 10. It should be understood that the thickness and size of each element as shown in FIG. 1 is not as per scale. Typically the repeating units 12 of the fuel cell assembly are coupled mechanically using a sealing arrangement (not shown in FIG. 1).

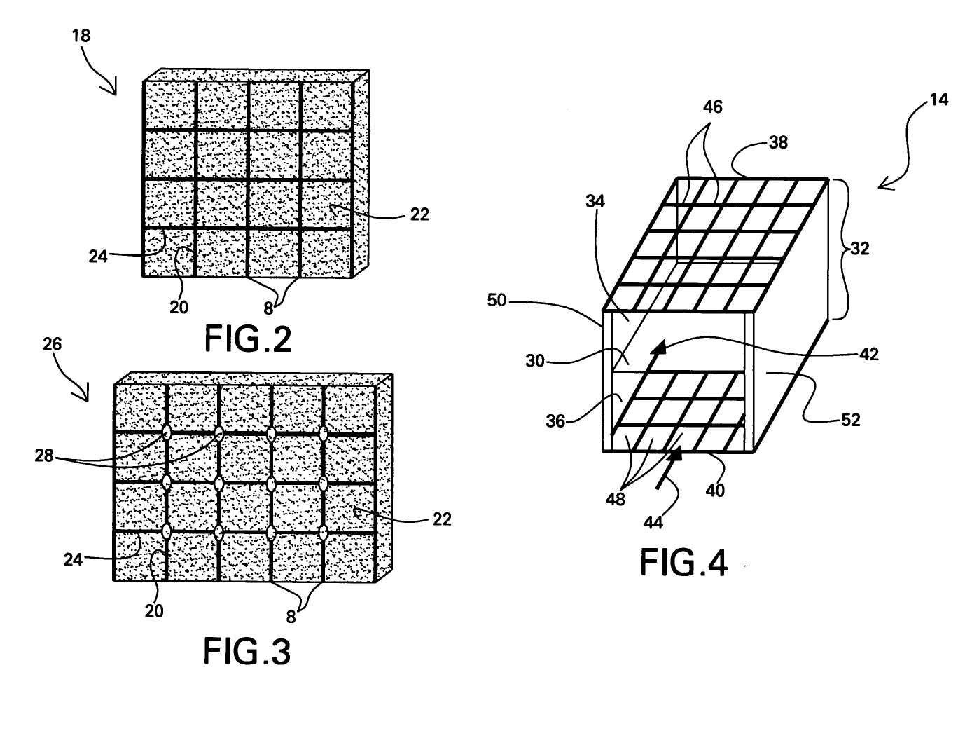

FIG. 2 shows a diagrammatical view 18 of an exemplary conducting layer 8 on an electrode 22, which conducting layer 8 is substantially hollow. For the purpose of understanding, a layer is defined as “substantially hollow”, wherein the openings in the layer is sufficiently large to provide a path for any gas, such as a fuel or an oxidant to pass through the openings to reach the anode and the cathode respectively. The electrode 22 may either be an anode or a cathode of a fuel cell. As show in FIG. 2, the conducting layer 8 on the electrode is in the form of a mesh, which mesh is formed by a plurality of vertical stripes 20 and horizontal stripes 24. Having both the vertical stripes 20 and the horizontal stripes 24 increases the current collection efficiency by decreasing the distance traveled by the electrons in the electrodes. Therefore the conducting layers 8 maximize the power efficiency in the fuel cell assembly 10 (as shown in FIG. 1). Additionally, the conducting layer 8 also improves the oxidation resistance of the interconnect (not shown in FIG. 2), which interconnect is in contact with the conducting layer 8. In some other embodiments, the conduction layer may be formed from a woven wire, felt or combination thereof. The conducting layer 8 comprises a material selected from a group consisting of suitable noble metals, rare earth metals, metallic alloys, cermets, and oxides or a combination thereof. The conducting layer 8 may comprise at least one material selected from gold, silver, platinum, palladium, iridium, ruthenium, rhodium, indium-tin-oxide (ITO), ruthenium oxide, rhodium oxide, iridium oxide, indium oxide and perovskite oxides. In some embodiments, the conducting layer 8 is chemically compatible with the material of the electrode 22, which electrode 22 may be one of an anode layer or a cathode layer. The conducting layer 8 has a thickness of the about 1 micron to about 250 micron, and more preferably from one micron to 50 micron. The conducting layer 8 is deposited or coated on the electrodes 22 covering up to about 15% of the area of the electrode 22. In some embodiments, the conducting layer is fused on the electrode 22. The vertical stripes 20 in the conducting layer 8 may have equal width of that of the contact region of the conducting layer 8 and the interconnect (not shown in FIG. 2). The vertical stripes 20 can be spaced such that they overlap on the contact region of the interconnect peaks in intimate contact with the conducting layer 8. The vertical stripes 20, which stripes 20 are in direct contact with the interconnect improve oxidation resistance of the interconnect material at the electrode-interconnect interface. The electrodes 22 typically comprises a ceramic material, which ceramic material have limited electrical conductivity. In operation, when electrons are generated at the triple phase boundary in the electrodes, they need to travel to the interconnect-electrode interface before they can be collected by the interconnect. The horizontal stripes 24 act as efficient current collectors from the electrodes as the electrons are transferred to the vertical stripes 20, which vertical stripes are in intimate contact with the interconnect. In some embodiments, the horizontal stripes 24 have less width compared to the width of the vertical stripes 20. Since the current collection efficiency is enhanced by the horizontal stripes 24, the vertical stripes 20 may have less width, without affecting the electron flow from the electrode 22 to the interconnect. This, in turn, may also improve the oxidation resistance of the interconnect, as the area of the interconnect in direct contact with the fuel cell gases, such as, a fuel and an oxidant is reduced. The interface resistance of the electrodes and the interconnects is also reduced due to the reduced contact area between the electrodes and the interconnects. Therefore the conducting layer 8, when deposited on the electrodes provides improved oxidation resistance and also increases the current collection efficiency in a fuel cell.

FIG. 3 illustrates a diagrammatical view 26 of yet another exemplary conducting layer 8 disposed on an electrode 22. The electrode 22 may either be an anode or a cathode of a fuel cell. The conducting layer 8 on the electrode 22 is in the form of a mesh, which mesh is formed by a plurality of vertical stripes 20 and horizontal stripes 24. The conducting layer 8 further comprises a plurality contact sites 28. The contact sites 28 are in intimate contact with the interconnect (not shown in FIG. 3), which interconnect has a plurality of cylindrical contact points in contact with the contact sites 28 of the conducting layer 8. The vertical and horizontal stripes 20 and 24, respectively improve the current collection efficiency, wherein the electrons flow to the interconnect from the electrode 22 through the contact sites 28.

FIGS. 4 to 8 illustrate designs of interconnects in various embodiments wherein like features are represented by like numerals. FIG. 4 illustrates a perspective view of an exemplary interconnect 14, which interconnect 14 is part of the fuel cell assembly 10 as shown in FIG. 1.

Interconnect 14 comprises a hollow manifold 32, which hollow manifold 32 is configured to distribute a fuel and an oxidant to the anode 2 and cathode 6 respectively (not shown in FIG. 4). The hollow manifold 32 further comprises a first sidewall 50 and a second sidewall 52 to define at least one enclosed chamber within the hollow manifold 32. The hollow manifold 32 comprises a top manifold 34 and a bottom manifold 36, which top manifold 34 and bottom manifold 36 are separated by a separator plate 30. The top manifold includes a top wall 38 and a bottom wall, which bottom wall is the separator plate 30. The bottom manifold 36 includes a top wall, which top wall is the separator plate 30 and a bottom wall 40. The top manifold 34 is in intimate contact with the cathode 6 (not shown in FIG. 4) and therefore acts as a cathode interconnect. The bottom manifold is in intimate contact with the anode 2 (not shown in FIG. 4) and therefore acts as an anode interconnect. The top manifold 34 is configured to provide a flow path 42 for the oxidant to be distributed evenly to the cathode 6, as shown in FIG. 1. The bottom manifold 36 is configured to provide a flow path 46 for the fuel to be distributed evenly to the anode 2, as shown in FIG. 1. The fuel flow path 44 and the oxidant flow path 42 are substantially parallel, wherein the fuel and the oxidant flow parallel to each other on either side of the divider 30 in the hollow manifold 32. The Top wall 38 of the top manifold 34 comprises at least one opening 46, which opening 46 is in fluid communication with the cathode 6. The bottom wall of the bottom manifold 36 further comprises at least one opening 48, which opening 48 is in fluid communication with the anode 2. More specifically, in the exemplary embodiment as shown in FIG. 4, a plurality of openings 46 extend through the top wall 38 into the top manifold 34 and a plurality of openings 48 extend through the bottom wall 40 into the bottom manifold 36. In the exemplary embodiment, openings 46 and 48 are arranged in a mesh structure, which mesh structure is substantially rectangular. The openings 46 and 48 in the top manifold 34 and the bottom manifold 36 maximize the oxidant and fuel availability to the cathode and the anode respectively, by optimizing the contact area between the incoming fuel and oxidant and the cathode and the anode. Higher fuel availability due to the interconnect design as shown in FIG. 4 improves the fuel utilization in the fuel cell assembly 10. The openings 46 and 48 in the top wall 38 and the bottom wall 40 may be manufactured by using methods including, but not limited to machining, metal punching and laser drilling. The top wall 38 and the bottom wall 40 are in intimate contact with the conducting layers 8 as shown in FIG. 1. In some embodiments, the conducting layers 8 may be directly disposed on the top wall 38 and the bottom wall 40.

The hollow manifold 32 is fabricated from an electrically conductive material, which conductive materials are capable of operating at higher temperatures as described herein, such as, but not limited to, stainless steel.

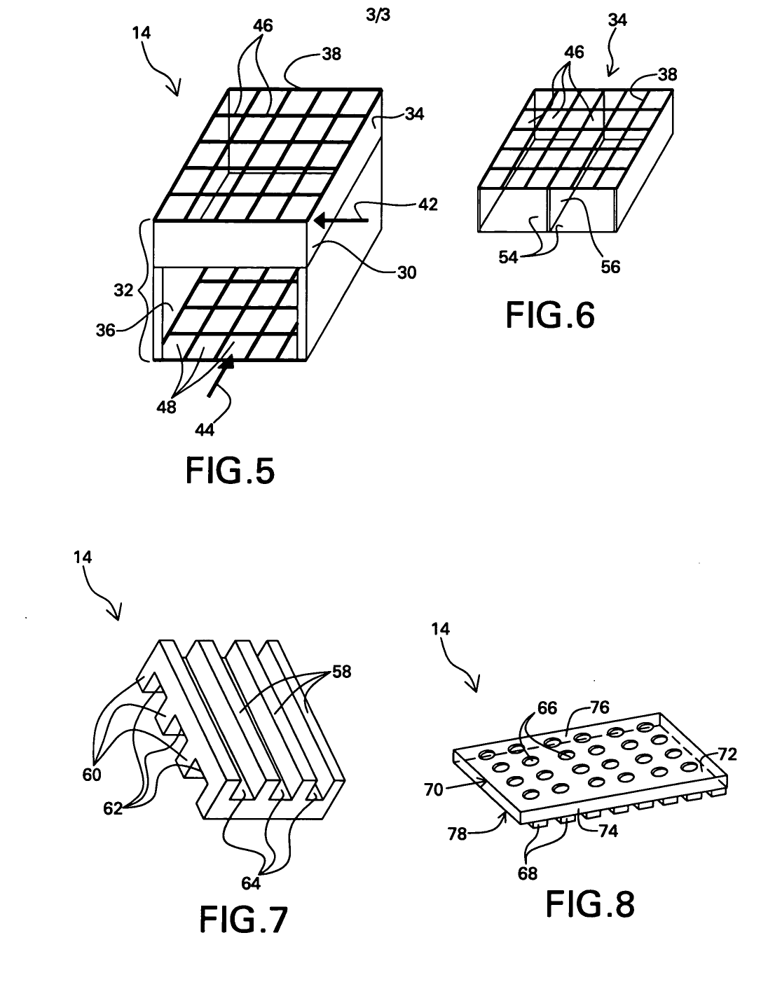

FIG. 5 illustrates a perspective view of yet another exemplary interconnect 14, which interconnect 14 is part of the fuel cell assembly 10 as shown in FIG. I. In the exemplary embodiment, as shown in FIG. 5, the flow path 42 for the oxidant and the flow path 44 for the fuel generate a cross current flow of the fuel and the oxidant. The top manifold 34 is in intimate contact with the cathode 6 (not shown in FIG. 5), which top manifold 34 acts as a cathode interconnect. The bottom manifold 36 is in intimate contact with the anode 2 (not shown in FIG. 5), which bottom manifold 36 acts as an anode interconnect. FIG. 6 illustrates a perspective view of an exemplary top manifold 34, which top manifold 34 is configured to have at least one flow channel divider 56, which divider divides the top manifold 34 into more than one flow channels 54. The flow channels 54 distribute the oxidant flow to the cathode 6 (not shown in FIG. 6) and flow channel divider 56 improves the structural integrity of the top manifold 34. Similarly the bottom manifold as shown in FIG. 4 may also have flow dividers for structural integrity and distribution of the fuel to the anode.

FIG. 7 illustrates a perspective view of another exemplary interconnect 14, which interconnect 14 is part of the fuel cell assembly 10 as shown in FIG. 1. The interconnect 14 acts as a bipolar plate wherein, both sides of the interconnects comprises dividers to provide passages for the fuel and the oxidant. On one side of the interconnect 14, a series of dividers 58 are provided for distribution of an oxidant to the cathode (not shown). On the other side of the interconnect 14, a series of dividers 60 are provided for distribution of a fuel to the anode (not shown). In a conventional interconnect, the area of the dividers 58 exposed to the cathode are designed such that sufficient contact is maintained with the cathode for current collection. In the disclosed embodiments, as shown in FIG. 1, the conducting layer enhances the current collection efficiency. Therefore the dividers 58 as shown in the FIG. 7 can have less width thereby providing wider channels 64 for oxidant distribution. Similarly the dividers 60 can have less width thereby providing wider channels 62 for fuel distribution to anode. The wider channels 64 and 60 for the distribution of oxidant and fuel respectively improves the fuel and oxidant distribution, which improved distribution, in turn, increases the power efficiency of a fuel cell.

FIG. 8 illustrates a perspective view of yet another exemplary interconnect 14, which interconnect 14 is part of the fuel cell assembly 10 as shown in FIG. 1. The interconnect 14 comprises a hollow manifold 70, which hollow manifold 70 is configured to distribute fuel to the anode 8 (not shown). The hollow manifold 70 includes a top wall 72 and a bottom wall 78. The hollow manifold 70 further comprises a pair of sidewalls 74 and 76 that connect the top and bottom walls 72 and 78, respectively. The top wall 72 of the hollow manifold 70 comprises at least one opening 66 to provide a flow communication between the fuel flowing through the hollow manifold 70 and the anode 8 (not shown) disposed on the top wall 72. More specifically, in the exemplary embodiment as shown in FIG. 8, a plurality of openings 66 extend through the top wall 72 into the hollow manifold 70. In the exemplary embodiment, openings 66 are arranged in a substantially collinear configuration, i.e., openings 66 are arranged in a plurality of rows, wherein each row includes a plurality of openings 66 arranged in a linear sequence. Additionally, in the exemplary embodiment, each opening 66 has a substantially circular cross-sectional profile. In some other embodiments, each opening 48 has a non-circular cross-sectional profile.

The fuel cell assembly as disclosed herein have several advantages as described in the previous sections. The conducting layer in intimate contact with the electrodes and the interconnects improves the oxidation resistance and the current collection efficiency. The interconnect or the bipolar plate as described in different embodiments, improves the fuel and oxidant distribution thereby increasing the powers efficiency of the fuel cell assembly disclosed herein.

Exemplary embodiments of fuel cell assemblies are described above in detail. The fuel cell assemblies are not limited to the specific embodiments described herein, but rather, components of each assembly may be utilized independently and separately from other components described herein. Each fuel cell assembly component can also be used in combination with other fuel cell stack components. For example, in certain embodiments, the relative positions of the anode and the cathode within the stack may be exchanged, and similarly passages defined for fuel flow and oxidant may also be exchanged.

Various embodiments of this invention have been described in fulfillment of the various needs that the invention meets. It should be recognized that these embodiments are merely illustrative of the principles of various embodiments of the present invention. Numerous modifications and adaptations thereof will be apparent to those skilled in the art without departing from the spirit and scope of the present invention. Thus, it is intended that the present invention cover all suitable modifications and variations as come within the scope of the appended claims and their equivalents.

1. A fuel cell assembly comprising a plurality of fuel cells, each of said fuel cells comprising
an anode layer, a cathode layer and an electrolyte interposed therebetween;
a conducting layer in intimate contact with at least one of said cathode layer and said anode layer;
wherein said conducting layer is configured to facilitate transport of electrons from said anode layer and said cathode layer.

2. The fuel cell assembly according to claim 1, wherein said conducting layer is disposed on at least one of said anode layer and said cathode layer.

3. The fuel cell assembly according to claim 1, wherein said conductive layer is substantially hollow.

4. The fuel cell assembly according to claim 1 wherein at least some of said fuel cells further comprise an anode interconnect to support said anode layer and a cathode interconnect to support said cathode layer.

5. The fuel cell assembly according to claim 4, wherein said conducting layer is disposed on at least one of said anode interconnect and said cathode interconnect.

6. The fuel cell assembly according to claim 4, wherein at least one of said anode interconnect and said cathode interconnect is a hollow manifold comprising a top wall, said top wall comprising at least one opening extending therethrough in flow communication with said hollow manifold.

7. The fuel cell assembly according to claim 6, wherein said hollow manifold is configured to provide a flowpath for at least one reactant selected from the group consisting of a fuel and an oxidant.

8. The fuel cell assembly according to claim 7, wherein said hollow manifold further comprises at least one separator sheet to separate said flow path of said fuel and said oxidant.

9. The fuel cell assembly according to claim 1, wherein said conducting layer has a shape selected from the group consisting of a mesh, a woven wire, a woven fiber, a felt and combinations thereof.

10. The fuel cell assembly according to claim 1, wherein said conductive layer has a thickness of about 1 micron to about 250 micron.

11. The fuel cell assembly according to claim 1, wherein said conductive layer has a thickness of about 1 micron to about 50 micron.

12. The fuel cell assembly according to claim 1, wherein said conducting layer is chemically compatible with one of said anode layer and said cathode layer.

13. The fuel cell assembly according to claim 1, wherein said conducting layer comprises a material selected from the group consisting of noble metals, metallic alloys, cermets, and oxides.

14. The fuel cell assembly according to claim 1, wherein said conductive layer comprises a material selected from the group consisting of gold, silver, platinum, palladium, iridium, ruthenium, rhodium, indium-tin-oxide, ruthenium oxide, rhodium oxide, iridium oxide and indium oxide.

15. The fuel cell assembly according to claim 1, wherein said fuel cell is selected from the group consisting of solid oxide fuel cells, direct methanol fuel cells, and protonic ceramic fuel cells.

16. The fuel cell assembly according to claim 1, wherein said fuel cell comprises a solid oxide fuel cell.

17. The fuel cell assembly according to claim 1 having one of a planar structure, a tubular structure and a combination thereof.

18. A fuel cell assembly comprising: a plurality of fuel cells, each of said fuel cells comprising
an anode layer, a cathode layer and an electrolyte interposed therebetween;
an anode interconnect to support said anode layer and a cathode interconnect to support said cathode layer; and
a conducting layer disposed on at least one of said cathode layer and said anode layer to reduce interface resistance between said anode layer and said anode interconnect and between said cathode layer and said cathode interconnect;
wherein said conducting layer is configured to facilitate transport of electrons from said anode layer and said cathode layer.

19. The fuel cell assembly according to claim 18, wherein said conductive layer is substantially hollow.

20. The fuel cell assembly according to claim 18, wherein at least one of said anode interconnect and said cathode interconnect is a hollow manifold comprising a top wall, said top wall comprising at least one opening extending therethrough in flow communication with said hollow manifold.

21. The fuel cell assembly according to claim 20, wherein said hollow manifold is configured to provide a flowpath for at least one reactant selected from the group consisting of a fuel and an oxidant.

22. The fuel cell assembly according to claim 21, wherein said hollow manifold further comprises at least one separator sheet to separate said flow path of said fuel and said oxidant.

23. The fuel cell assembly according to claim 18, wherein said conducting layer has a shape selected from the group consisting of a mesh, a woven wire, a woven fiber, a felt and combinations thereof.

24. The fuel cell assembly according to claim 18, wherein said conducting layer is chemically compatible with one of said anode layer and said cathode layer.

25. The fuel cell assembly according to claim 18, wherein said conducting layer comprises of a material selected from the group consisted of noble metals, metallic alloys, cermets, and oxides.

26. The fuel cell assembly according to claim 18, wherein said conductive layer comprises a material selected from the group consisting of gold, silver, platinum, palladium, iridium, ruthenium, rhodium, indium-tin-oxide, ruthenium oxide, rhodium oxide, iridium oxide and indium oxide.

27. The fuel cell assembly according to claim 18, wherein said fuel cell is selected from the group consisting of solid oxide fuel cells, direct methanol fuel cells, and protonic ceramic fuel cells.

28. The fuel cell assembly according to claim 18, wherein said fuel cell comprises a solid oxide fuel cell.

29. The fuel cell assembly according to claim 18 having one of a planar structure, a tubular structure and a combination thereof.

30. A fuel cell assembly comprising a plurality of fuel cells, each of said fuel cells comprising
an anode layer, a cathode layer and an electrolyte interposed therebetween;
an anode interconnect to support said anode layer and a cathode interconnect to support said cathode layer; and
a conducting layer disposed on at least one of said cathode layer and said anode layer to reduce interface resistance between said anode layer and said anode interconnect and between said cathode layer and said cathode interconnect;
wherein at least one of said anode interconnect and said cathode interconnect is a hollow manifold comprising a top wall, a first side wall and a second side wall, said top wall, first side wall and second side wall defining a chamber therein, said top wall comprising at least one opening extending therethrough in flow communication with said chamber and said conducting layer is configured to facilitate transport of electrons from said anode layer and said cathode layer.
